(19) United States
(12) Patent Application Publication
(10) Pub. No.: US 2026/0141466 A1
(43) Pub. Date: May 21, 2026

(54) Computing System and Method for Controlling a Construction Management Software Application Via Natural-Language Requests

(71) Applicant: Procore Technologies, Inc., Carpinteria, CA (US)

(72) Inventors: Mark Alexander Tyrrell, Round Rock, TX (US); Deepak Jayaram, Boston, MA (US); Hemendra Pal, Round Rock, TX (US); Samuel Thomas Weston Butler, Austin, TX (US); Timothy John Parmentier, Bend, OR (US)

(21) Appl. No.: 18/952,922

(22) Filed: Nov. 19, 2024

(51) Int. Cl. G06Q 50/08; G06F 8/41

(52) U.S. Cl. CPC G06Q 50/08; G06F 8/41

(57) ABSTRACT

A computing system is configured to: (i) receive a natural-language request for performing actions related to a software tool of a construction management software application, (ii) based on the natural-language request, generate a prompt for a generative AI model having a request to determine functions for the software tool to use in one or more function calls to perform actions using the software tool, (iii) in response to the prompt, receive, from the generative AI model, a response that comprises an identification of one or more determined functions of the defined set of functions to utilize in one or more function calls, (iv) based on the response, either extract or construct the one or more function calls, (v) based on the one or more function calls, perform the one or more actions within the software tool, (vi) present an indication that the actions have been performed within the software tool.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new software-based technology for generating construction-based data objects via a unified user interface that provides a user with input fields that correspond with each of a set of user-selectable types of construction-based data objects.

In one aspect, the disclosed technology may take the form of a method that involves (i) receiving, from a client device, a natural-language request for performing one or more actions related to a software tool of a construction management software application, (ii) based on the natural-language request, generating a prompt for a generative AI model that comprises a request to determine which of a defined set of functions for the software tool to use in one or more function calls in order to perform one or more actions using the software tool, (iii) passing the prompt to the generative AI model, (iv) receiving, from the generative AI model, a response that comprises an identification of one or more determined functions of the defined set of functions to utilize in one or more function calls, (v) based on the response, either (a) extracting the one or more function calls from the response or (b) constructing the one or more function calls, (vi) based on the one or more function calls, performing the one or more actions within the software tool, (vii) presenting, using the client device, an indication that the one or more actions have been performed within the software tool.

The prompt may take any of various forms. For example, the prompt may include the defined set of functions for the software tool.

The determined functions of the defined set of functions may take any of various forms. For example, one or more of the determined functions of the defined set of functions may include one or more respective function arguments. In such an example, the prompt may include a request to generate values for each of the one or more respective function arguments. Further, in an example, the prompt may include a request to, based on the determined functions of the defined set of functions and the generated values for each of the one or more respective functions, generate the one or more function calls. In another further example, the functionality for, based on the determined functions of the defined set of functions and the generated values for each of the one or more respective functions, generating the one or more function calls may include based on the determined functions of the defined set of functions and the generated values for each of the one or more respective functions, constructing the one or more function calls. In yet a further example, the functionality for, based on the determined functions of the defined set of functions and the generated values for each of the one or more respective functions, construct the one or more function calls, may include (i) generating a function-call prompt comprising a request to, based on the received response, generate the one or more function calls, (ii) passing the function-call prompt to an AI model, and (iii) receiving a function-call response from the AI model comprising one or more generated function calls for the one or more function calls.

The functionality for generating the prompt for the generative AI model may take any of various forms. For example, the functionality for generating the prompt for the generative AI model may include (i) identifying at least one of a plurality of candidate AI agents that is to be utilized to handle the natural-language request and thereby determine where to route the natural-language request, (ii) routing the natural-language request to the identified at least one candidate AI agent for handling the natural-language request. In this example, the plurality of candidate AI agents may include the AI agent.

The software tool may take any of various forms. For example, the software tool may comprise a schedule tool of the construction management software application.

In another aspect, the disclosed technology may take the form of a computing system comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which example embodiments may be implemented.

FIG. 2A depicts a first Schedule view of a Schedule GUI of a Schedule tool of a construction management software application.

FIG. 2B depicts a second Schedule view of the Schedule GUI of the Schedule tool of FIG. 2A.

FIG. 2C depicts a third Schedule view of the Schedule GUI of the Schedule tool of FIGS. 2A and 2B.

FIG. 2D depicts a fourth Schedule view of the Schedule GUI of the Schedule tool of FIGS. 2A-2C.

FIG. 3 depicts an example block diagram for an AI-based software architecture 300 that enables a user to control a construction management software application through input of natural-language requests.

FIG. 4A depicts a GUI view comprising an example schedule view that is overlaid with a chat interface that enables a user to input a natural-language request as input for the AI-based software architecture.

FIG. 4B depicts another GUI view of the schedule view that is overlaid with the chat interface of FIG. 4A.

FIG. 5 depicts a communication diagram that depicts communications between components shown in FIG. 3 and is shown in accordance with the functionality disclosed herein.

FIG. 6 depicts one possible implementation of functionality that may be carried out by the example AI-based software architecture of FIG. 3.

FIG. 7 is a simplified block diagram illustrating some structural components that may be included in an example computing platform that may be configured to perform some or all of the server-side functions disclosed herein.

FIG. 8 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (SaaS) application, among other possibilities. As another possible implementation, a construction management software application may include front-end software that runs on client devices without interaction with a back-end computing platform. These construction management software applications may take other forms as well.

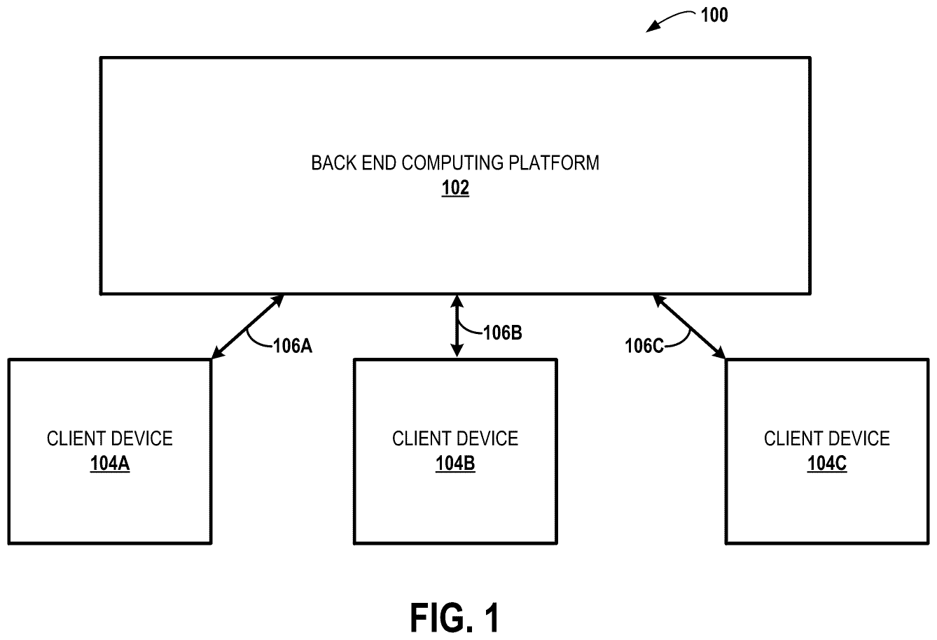

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

When a given party (e.g., a company or individual involved in the construction industry) wishes to utilize an existing construction management software application, the given party may begin by (i) creating an account with the construction management software application and (ii) adding a set of one or more individuals associated with the given party as users on the given party's account. Thereafter, the construction management software application may enable the users of the given party to created, stored, viewed, and/or interacted with digital data related to construction projects that involve the given party.

For instance, for each of one or more construction projects that involve the given party, the construction management software application may enable users of the given party to create a new project workspace for the construction project (or join an existing project workspace for the construction project that was previously created) and then (ii) create, store, view, and/or interact with any of various types of data objects related to management of construction projects.

In practice, each different type of data object that is supported by a construction management software application may be designed to serve a particular purpose within the construction management software application and may comprise a particular set of data elements that facilitate that particular purpose. For instance, a first type of data object may be designed to serve a first purpose within the construction management software application and may comprise a first set of data elements, a second type of project-related data object may be designed to serve a second purpose within the construction management software application and may comprise a second set of data elements that differs from the first set of data elements, and so on for each of the other types of data objects. In this way, the users of the construction management software application may utilize different types of data objects to manage different aspects of the construction project.

As some representative examples, the types of data objects that may be supported by a construction management software application may include schedule-item data objects (e.g., a data object comprising data that represents a task, event, or milestone within a construction schedule for a construction project), submittal data objects (e.g., a data object comprising data that represents an item submitted by a responsible contractor to a general contractor of a construction project for review and approval), observations data objects (e.g., a record of observed conditions and/or associated effects of said conditions during a construction project at a point in time during the course of the construction project), punch list and/or punch item data objects (e.g., a record of which list work on a construction project that has not yet been completed or has been completed incorrectly), daily log data objects (e.g., records of construction activity within a given timeframe, such as a day), request for information (“RFI”) data objects (e.g., a record of request for information from one user/party to another user/party and/or the information provided in response to said request), inspections data objects (e.g., a record of an inspection of a site at some point in time during the course of a construction project), among other types of construction-related data objects.

In at least some implementations, the software features for creating, storing, viewing, and/or interacting with the different types of data objects that are supported by a construction management software application may be arranged into different software “tools” that each correspond to a different type of data object. For instance, a construction management software application may include a “Schedule” tool for creating, storing, viewing, and/or interacting with schedules comprising schedule-item data objects, a “Submittals” tool for creating, storing, viewing, and/or interacting with observation data objects, an “Observations” tool for creating, storing, viewing, and/or interacting with observation data objects, a “Punch Items/Lists” tool for creating, storing, viewing, and/or interacting with punch list and/or punch item data objects, a “Daily Logs” tool for creating, storing, viewing, and/or interacting with daily log data objects, a “RFIs” tool for creating storing, viewing, and/or interacting with RFI data objects, and/or an “Inspections” tool for creating, storing, viewing, and/or interacting with inspection data objects, among various other examples of software tools that may be included within a construction management software application. However, in other implementations, the software features for creating, storing, viewing, and/or interacting with the different types of data objects that are supported by a construction management software application may be arranged in other manners (e.g., software features that operate across multiple different types of data objects) that are not based solely on a software tools paradigm.

In general, each such software tool has its own respective graphic user interface (GUI) that may be utilized by a user to perform various actions within the software tool, such as actions related to creating, storing, viewing, and/or interacting with data objects of a type that is associated with the software tool. To provide functionality related to these actions, the GUI for the software tool may comprise various individual GUI views (also sometimes referred to as screens or pages of the GUI), and in order to carry out actions via the GUI of a software tool, a user may need to navigate through multiple different GUI views and/or may need to provide multiple different GUI inputs.

A Schedule tool of Procore's construction management software application is one example of a software tool that has a GUI (a “Schedule GUI”) that comprises various individual GUI views (“Schedule GUI views”). In general, the Schedule tool and its Schedule GUI views provide software features for creating, storing, viewing, and/or interacting with schedules for construction projects (i.e., construction schedules), wherein the construction schedules each comprise schedule items (e.g., a task, an event, or a milestone that is related to a construction project) that are represented by schedule-item data objects. Each such schedule-item data object may represents a task (a “schedule task”), an event (a “schedule event”), or a milestone (a “schedule milestone”) that may be included as part of a construction schedule, among other possibilities. Further, each such schedule-item data object may contain any of various data about a represented schedule item, including but not limited to an indication of what the schedule item involves (e.g., a textual description), timing data for each of the schedule items (e.g., a start and end date for the schedule item), an indication of parties involved in the represented schedule item, and/or an indication of one or more dependencies between the represented schedule item and one or more other schedule items, among other possible types of data that may be included in a schedule-item data object.

Schedule-item data objects may be generated by the Schedule tool in various ways. In one example, a schedule-item data object may be generated by the Schedule tool receiving data, as input, for a schedule item and populating data fields of a schedule-item data object based on the received data. In practice, this may take the form of the user inputting the data via one or more input-control elements of a Schedule GUI view of the Schedule GUI. In another example, schedule-item data objects may be generated based on a bulk data upload (e.g., a spreadsheet containing schedule-item data, etc.) that is then processed by the Schedule tool to extract the schedule-item data from the bulk data upload and generating schedule-item data objects based thereon. In practice, this may take the form of (i) the Schedule tool receiving the bulk data upload (e.g., via the user uploading the bulk data upload via an uploader presented in a Schedule GUI), (ii) the Schedule tool determining what data within the bulk data upload is schedule-item data, and (iii) based on the determined schedule-item data, the Schedule tool generating one or more schedule-item data objects.

The Schedule tool may generate visual representations of a construction schedule based on a set of schedule-item data objects representing the schedule items to be included in the construction schedule. These visual representations of the construction schedule then may be presented to a user via one or more of the Schedule GUI views of the Schedule GUI. In general, the visual representations of the construction schedule depict visual representations of schedule items included in the construction schedule in a textual and/or graphical form. Further, the visual representations may indicate the timing data for the schedule items, dependencies between schedule items, and/or sequencing of schedule items, among other possible types of information that may be included in the visual representations. Examples of the visual representations include, but are not limited to including, a list, a calendar, a Gantt chart, a lookahead view, etc. The visual representations may take various other forms, as well.

Presenting the visual representations of the construction schedule is one example of an action related to a construction schedule (a “schedule action”) that can be performed in the Schedule tool using the Schedule GUI. The Schedule GUI may be utilized by the user to perform various other actions within the Schedule tool as well. Examples of the schedule actions that are related to schedule-item data objects include, but are not limited to including, creating a schedule-item data object, viewing a schedule-item data object, altering a schedule-item data object (e.g., changing one or more attributes of the schedule item, such as a date, a time, parties involved in the schedule item), etc. The schedule actions may take various other forms, as well.

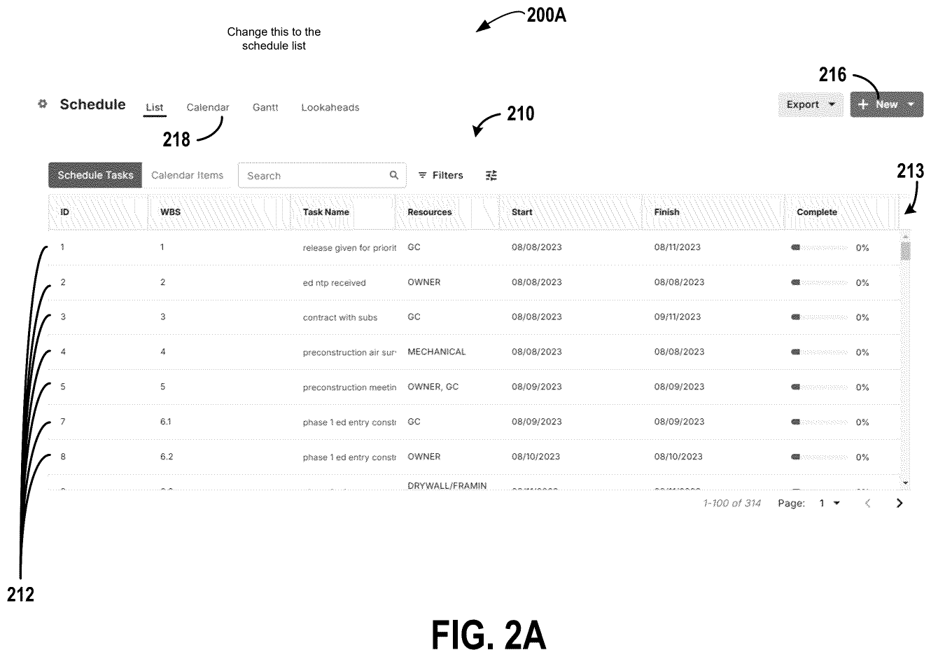

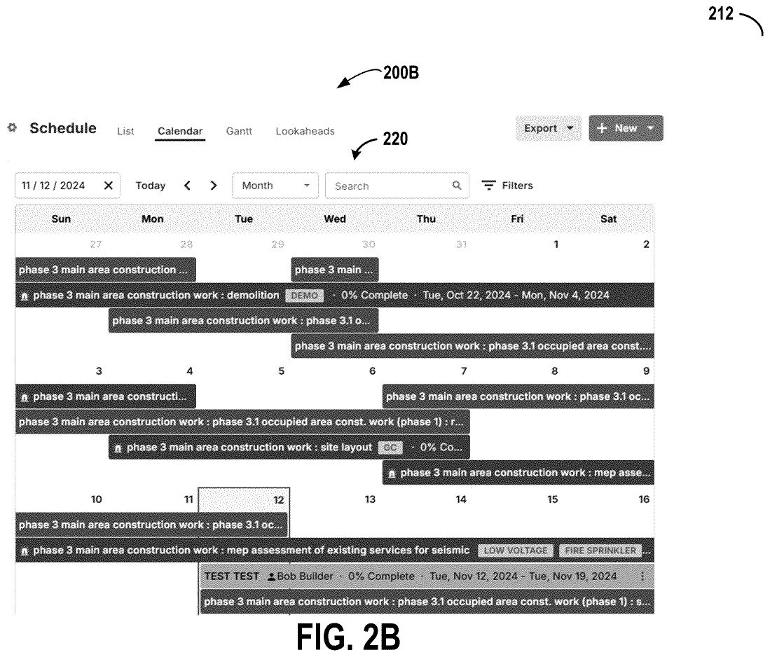

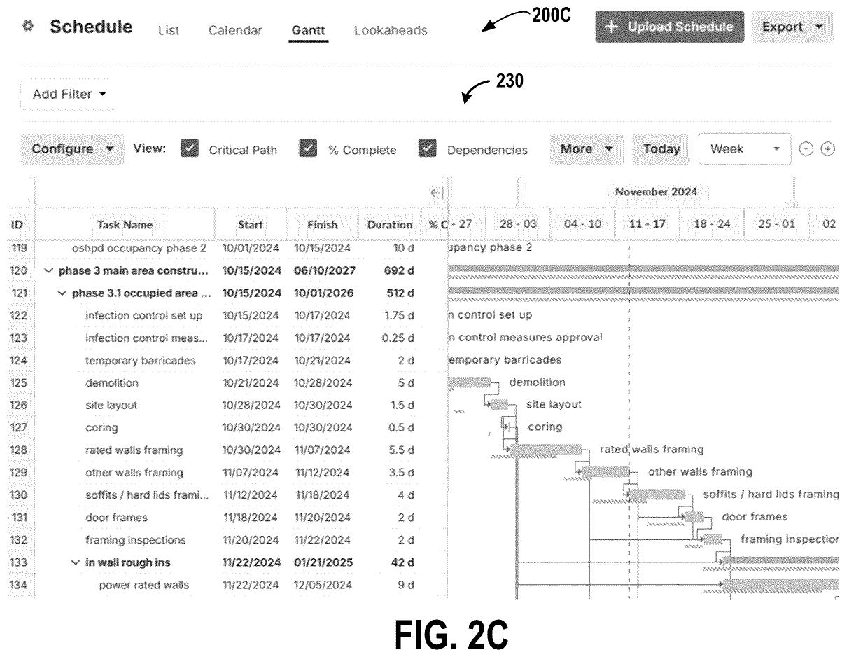

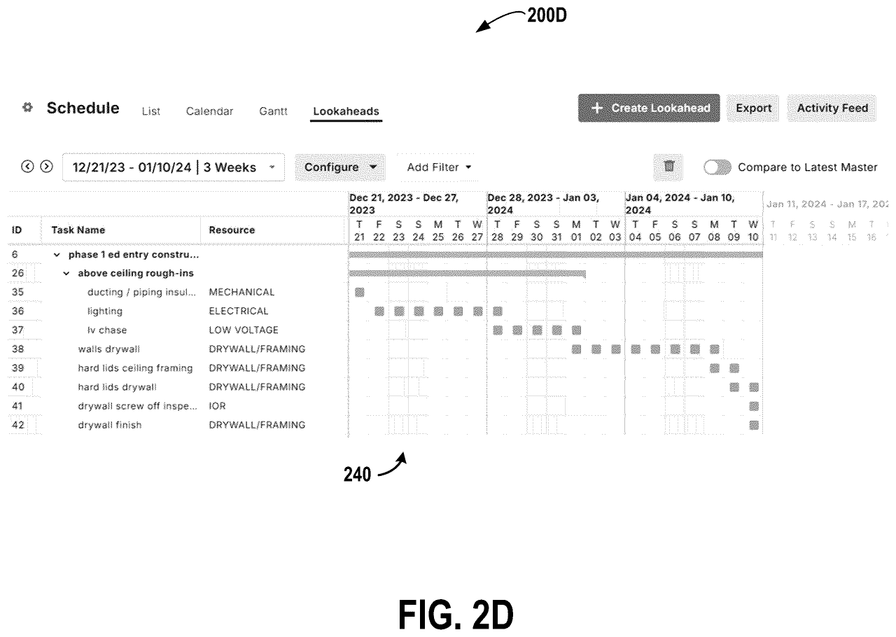

Turning to FIG. 2A, one illustrative example of a Schedule GUI view 200A of the Schedule GUI is shown. In line with the discussion above, the Schedule GUI view 200A may enable a user to perform one or more schedule actions.

As shown, the Schedule GUI view 200A includes a list view 210 for the construction schedule, which comprises line items 212 representing respective schedule-item data objects that have been created and stored for the construction schedule. The list view 210 is one of the visual representations that can be generated using the Schedule tool. The list view also includes a header row 213 that identifies the data fields of the schedule-item data objects represented by the line items 212. As shown, the header row indicates that there are data fields with names such as “ID” (ID number), “Task Name” (the name of a schedule item), “resource” (a category of a resource associated with a schedule item), “Start” to “Finish” (a duration of time that a schedule item is expected to be carried out), and “Complete” (a percentage of the construction project that is complete). A list view may take various other forms (e.g., including additional or alternative data fields in a header row), as well.

As shown, the first Schedule GUI view 200A also includes one or more input-control elements that enable a user to request that the Schedule tool perform schedule actions related to the construction schedule. For example, the first Schedule GUI view 200A includes a button 216 which enables the user to create a new schedule-item data object for the construction schedule. When the user inputs a request to create the new schedule-item data object by, for example, clicking the button 216, the Schedule tool may either (i) generate and present, to the user, another GUI view that enables the user to input data for the new schedule-item data object or (ii) generate and present, to the user, an altered version of the first Schedule GUI view 200A that is altered to enable the user to input data for the new schedule-item data object (e.g., in the form of one or more input-control elements presented in the first Schedule GUI view 200A within one or more of a pop up, a sidebar, an overlay, etc.).

As further shown, the first Schedule GUI view 200A may include a type-selector set of links 218, which is an input-control element that enables a user to change the type of visual representation of the schedule that is presented to the user via the Schedule GUI. For example, the type-selector set of links 218 may include a set of clickable links (e.g., a “List” link, a “Calendar” link, a “Gantt” link, a “Lookaheads” link, as shown), each of which, when clicked, indicates a request from the user to change the first Schedule GUI view 200A, showing the list view 210, to another Schedule GUI view that shows another one of the visual representations that can be generated using the Schedule tool.

Consider that the user clicks on the Calendar link of the type-selector set of links 218. Then, as illustrated in FIG. 2B, the Schedule tool may update the Schedule GUI to a second Schedule GUI view 200B. As shown, the second GUI view includes a calendar view 220 for the construction schedule, which shows representations of the schedule-item data objects that are illustrative of the represented schedule items in the form of a calendar. The schedule items are presented, for example, by overlaying each of the representations of the schedule-item data objects over a set of dates that are indicative of the range of dates during which the schedule item is to be carried out.

With reference to either the second Schedule GUI view 200B of FIG. 2B or the first Schedule GUI view 200A of FIG. 1, consider that the user clicks on the Gantt link of the type-selector set of links 218. Then, as illustrated in FIG. 2C, the Schedule tool may update the Schedule GUI to a third Schedule GUI view 200C. As shown, the third Schedule GUI view 200C includes a Gantt-chart view 230 for the construction schedule, which shows visual representations of the schedule-item data objects in the form of a Gannt chart. A Gannt chart is a type of bar chart that may include a start date and a finish date of each schedule item within the construction schedule and any dependencies between schedule items that are represented by respective schedule items (for instances where the start and/or completion of one given schedule item depends on the completion of another schedule item).

With reference to any of the Schedule GUI views 200A, 200B, 200C of, respectively, FIGS. 2A, 2B, 2C, consider that the user clicks on the Lookaheads link of the type-selector set of links 218. Then, as illustrated in FIG. 2D, the Schedule tool may update the Schedule GUI to a fourth Schedule GUI view 200D. As shown, the fourth Schedule GUI view 200D includes a lookahead view 240 for the construction schedule, which shows representations of the schedule-item data objects for submittal items that are included in a lookahead schedule. A lookahead schedule may comprise schedule items for an upcoming period of time (e.g., the upcoming 1 to 6 weeks), and the visual representation of the lookahead schedule may provide a more detailed view of the schedule items than the other views. As shown, the lookahead schedule may be presented in the form of a Gantt chart that includes a more detailed look at the schedule items.

While GUIs for software tools provide useful functionality for performing actions related to a construction schedule, GUIs having a variety of GUI views may also present problems for the user of the construction management software application. For example, these GUIs may require multiple user inputs (e.g., multiple input entries via multiple input-control elements) to perform a single action. Additionally, these multiple user inputs may require that multiple different GUI views of the software tool be accessed and used, requiring the user to navigate through multiple different GUI views in order to perform an action. To that end, the number of user inputs and/or GUI views that are required to accomplish a task could become quite large.

The multiple user inputs and/or multiple GUI views that may be required to perform an action may make using a software tool cumbersome, inefficient, and/or time consuming for a user (and perhaps lead the user to not even attempt to perform actions at all, using the software tool). Additionally, the multiple user inputs and/or multiple GUI views that may be required to perform an action within a software tool may lead to problems on the construction project given the drawbacks, such as inefficiencies. Additionally yet, the multiple user inputs and/or multiple GUI views that may be required to perform an action may also lead to user error when the user performs an action (e.g., erroneous user input, such as mistyped data, wrong clicks on elements, etc.).

These problems may be exacerbated for users that are attempting to use the construction management software application out in the field (e.g., at a construction site for a construction project or en route to the construction site). Many users of construction management software applications are construction professionals that spend some of their time on construction sites or travelling between construction sites. These users often access and use the construction management software application on mobile devices, such as smartphones, tablets, and the like. However, requiring multiple user inputs and/or navigation through multiple GUI screens in order to accomplish tasks within the construction management software application can be even more challenging for these users due to smaller screen sizes of mobile devices and/or limitations on the available input modalities (e.g., touchscreen input vs. mouse and keyboard input, etc.).

To address these and other problems associated with existing construction management software applications, disclosed herein is new software technology that utilizes artificial intelligence (AI) to enable a user to control a construction management software application through input of natural-language requests (e.g., text-based and/or voice-based requests). At a high level, the disclosed software technology comprises (i) front-end software that interacts with the user by receiving natural-language requests for controlling a construction management software application and (ii) back-end software that interprets and executes the natural-language requests for controlling the construction management software application. In practice, the back-end software may function to (i) receive a natural-language request to perform one or more actions within a software tool of the construction management software tool that was input by a user of a client device running the front-end software, (ii) based on the natural-language request, generate a prompt for a generative AI model that comprises a request to determine which of a defined set of functions for the software tool of the construction management software tool to call, (iii) receive a response from the generative AI model that comprises an indication of one or more functions to be used in one or more function calls, as determined by the generative AI model, and (iv) execute the one or more function calls in order to interact with the software tool and thereby cause the one or more actions requested by the user to be carried out.

The functionality that is provided by the disclosed software-based technology may take other forms as well.

The disclosed software technology improves upon existing construction management software applications by providing AI-based technology for interacting with various tools of construction management software applications in various ways. For instance, instead of requiring a user to navigate through a variety of GUI views to perform actions using a software tool, the users may now perform these actions by interacting with fewer GUI views (e.g., a GUI view (and its updated forms) that provides a chat interface for a user to input a natural-language request that is indicative of a request to perform an action related to the software tool). Further still, instead of requiring the user to provide multiple inputs for specific attribute values related to a function that the software tool may use to perform the action related to the software tool, by using the disclosed AI-based software architecture, the user need not enter these attribute values, but rather, the AI-based software architecture may generate values for these attributes, which are then used in executing the function via one or more function calls. These improvements provided by the disclosed AI-based software architecture simplify the process of interacting with the software tool for performing various actions and their use may improve user-experience of construction management software applications.

In particular, these improvements may be particularly pronounced when the user uses the disclosed technology to engage with the construction management software application when the user uses the construction management software application out in the field. For example, instead of requiring the GUI-view navigation and data input on the user's mobile device, as discussed above-now, to perform an action related to the software tool, the user in the field may utilize the disclosed technology to perform actions by way of input of a natural-language request, in either a text form or an audio form (e.g., speech recorded via a client device).

The improvements that are provided by the disclosed software technology are described in further detail below.

In practice, the disclosed software-based technology may be integrated into a construction management software application or provided as a standalone software tool, among other possibilities. For instance, as one possible implementation, the disclosed software-based technology may be integrated into a construction management software application comprising both front-end software running on client devices (e.g., client devices 104A-C of FIG. 1) that are accessible to individuals associated with construction projects (e.g., contractors, project managers, architects, engineers, designers, etc.) and back-end software running on a back-end computing platform (e.g., back-end computing platform 102 of FIG. 1) that interacts with and/or drives the front-end software. As another possible implementation, the disclosed software-based technology may be integrated into a construction management software application comprising front-end client software that runs on client devices without interaction with a back-end computing platform. The disclosed software-based technology may take other forms as well.

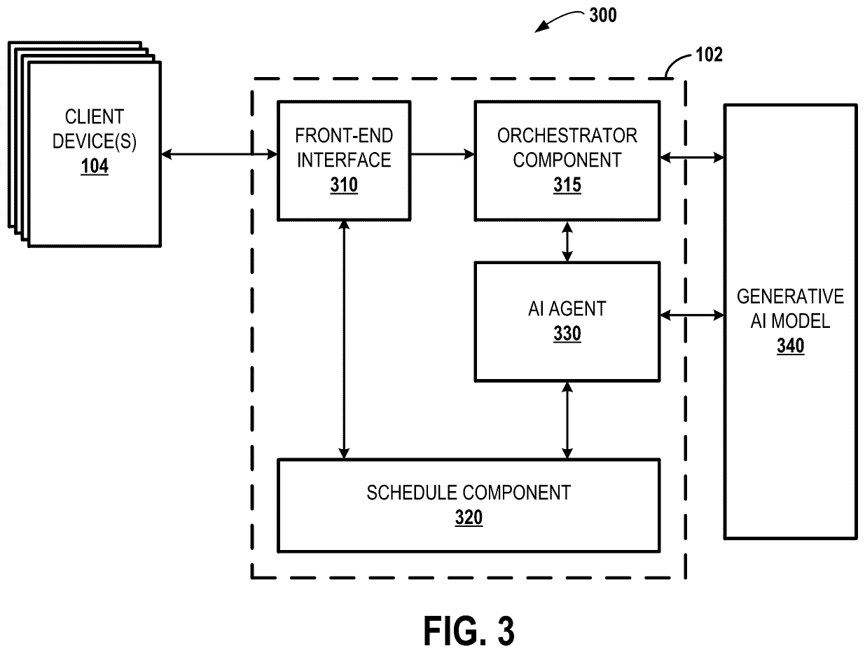

Turning now to FIG. 3, an example block diagram for an AI-based software architecture 300 that enables a user to control a construction management software application through input of natural-language requests is illustrated. In practice, the example AI-based software architecture 300 may be encoded in the form of program instructions that are executable by one or more processors of a computing platform, and for purposes of illustration, the AI-based software architecture 300 is described as being installed on and executed by the back-end computing platform 102 of FIG. 1, but it should be understood that the example AI-based software architecture 300 may be installed on and executed by any one or more computing platforms that are capable of performing the example operations of the AI-based software architecture 300. Further, it should be understood that the example AI-based software architecture 300 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular example.

The AI-based software architecture 300 will be described below with reference to controlling a Schedule tool of a construction management software application, but it should be understood that the AI-based software architecture 300 could apply to controlling other software tools and/or functionalities of a construction management software application.

As shown in FIG. 3, the example AI-based software architecture 300 comprises a front-end interface 310, a back-end software component for the Schedule tool that is referred to herein as a schedule component 320, and an AI agent 330, among other possible components that may be included in the example AI-based software architecture 300. Additionally, as shown in FIG. 3, the AI-based software architecture 300 may interface with client devices 104 running front-end software for the construction management software application, which may include front-end software for the disclosed software technology. Additionally yet, as shown in FIG. 3, the example AI-based software architecture 300 may interface with at least one generative AI model 340, which may either be hosted on a separate computing system that is accessible over a network-based communication path (e.g., via an API or the like) or be hosted on the back-end computing platform 102. Each of these components will now be described in further detail.

To begin, a client device 104 runs disclosed front-end software that generally functions to provide an input/output interface between a user of the client device 104 and the back-end computing platform 102 that hosts the construction management software application. At a high level, to the disclosed front-end software may provide functionality for (i) presenting the user with an interface for inputting natural-language requests for controlling the construction management software application and/or software tools thereof (e.g., the Schedule tool) and (ii) transmit natural-language requests that are input by the user to the back-end computing platform 102. Each of these functions may take any of various forms.

For instance, as one possibility, the function of presenting the user interface for inputting natural-language requests for controlling the construction management software application and/or software tools thereof may involve (i) receiving a communication from the back-end computing platform 102 that instructs the client device 104 to present the user with the user interface, and (ii) thereafter presenting the user with the user interface (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The function of presenting the user with the interface for inputting natural-language requests may take various other forms as well.

Further, the interface may enable the user to input natural-language requests in any of various manners. For instance, as one possibility, a user may access and use the front-end software running on the client device 104 to input a text-based natural-language request and/or a voice-based natural-language request (e.g., via a chat interface or the like). The interface may enable the user to input natural-language requests in other manners as well.

Further yet, the interface for inputting natural-language requests may take any of various forms. For instance, the interface for inputting natural-language requests may comprise a GUI view that includes one or more input-control elements (e.g., a text box) that enable the user to input natural-language requests in a text format. In one example, the GUI view may comprise a chat interface that may be accessed within the GUI view, beside the GUI view, or overlaid on the GUI view. Additionally or alternatively, the interface for inputting natural-language requests may comprise an input-control element that enables a user to initiate a session for inputting natural-language requests in an audio format using an I/O component of the client device 104 that captures audio (e.g., a microphone). The interface for inputting natural-language request may take various other forms, as well.

After the client device 104 running the front-end software receives the natural-language request, it then transmits the natural-language request to the front-end interface 310. In practice, the client device 104 may encode the natural-language request into a communication that is sent to the back-end computing platform 102. This communication may take the form of one or more messages (e.g., one or more HTTP messages) that are sent over the communication path 106 between the client device 104 and the back-end computing platform 102, and in at least some implementations, the communication may be sent via one or more APIs.

The front-end interface 310 generally functions to interface with the client device(s) 104 running the front-end software for the construction management software application, so as to receive communications from the client devices 104 via the communication paths 106 and/or send communications to the client devices 104 via the communication paths 106. For instance, at a high level, the functionality performed by the front-end interface 310 in accordance with the present disclosure may involve (i) receiving, from one of the client devices 104, a natural-language request for performing one or more actions related to a software tool (e.g., the Schedule tool) and (ii) passing the received natural-language request to the orchestrator component 315, (iii) receiving a response comprising an indication of a response to the natural-language request, and (iv) based on the response, causing the client device 104 to update the Schedule GUI being presented to the user to reflect any action that has been performed within the Schedule tool and perhaps also to show a textual response to the user's the natural-language request (e.g., a description of what actions, if any, were performed based on the natural-language request.

The natural-language request that is received by the front-end interface 310 may take any of various forms. For instance, natural-language request may comprise a request for the Schedule tool to perform one or more actions related to a given construction schedule. In other words, the natural-language request may include an instruction, a question, or the like that can be interpreted as a request for the Schedule tool to perform one or more actions related to the given construction schedule.

Further, the function of causing the client device 104 to update the Schedule GUI being presented to the user to reflect any action that has been performed within the Schedule tool, and perhaps also to show a textual response to the user's the natural-language request, may take any of various forms. For instance, as one possibility, the function of causing the client device 104 to update the Schedule GUI being presented to the user to reflect any action that has been performed within the Schedule tool, and perhaps also to show a textual response to the user's the natural-language request may involve (i) the back-end computing platform 102 transmitting a communication to the client device 104 that instructs the client device 104 to present the user with a Schedule GUI updated to reflect any action that has been performed within the schedule tool, and perhaps also to show a textual response to the user's natural-language request, (ii) the client device 104 receiving the communication, and (iii) the client device 104 thereafter presenting the user with the Schedule GUI updated to reflect any action that has been performed within the schedule tool, and perhaps also to show a textual response to the user's natural-language request (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The front-end interface 310 may perform other functions as well, including but not limited to the possibility that the front-end interface 310 may exchange other types of communications from the client devices 104 that do not involve natural-language queries.

Further, in other implementations, the front-end interface 310 may be configured to pass requests to and/or receive responses from other components of the AI-based software architecture 300, such as such as the orchestrator component 315 that is configured to evaluate and route incoming requests to AI agents and then relay responses from the AI agents back to the front-end interface 310.

As noted above, the schedule component 320 comprises the back-end software for the Schedule tool (e.g., the Schedule tool discussed above and with respect to FIGS. 2A-2D). In this respect, the schedule component 320 may carry out the back-end functionality for the Schedule tool, including but not limited to back-end functionality related to creating, storing, presenting, and/or updating schedule-item data objects. Further, in accordance with the present disclosure, the schedule component 320 may additionally function to (i) receive one or more function calls from the AI agent 330 (e.g., via an API or the like) and (ii) perform one or more actions based on the one or more function calls, such as functions related to creating, storing, presenting, and/or updating schedule-item data objects.

The one or more function calls that may be received from the AI agent 330 may take any of various forms. In practice, a function call may be defined as instructions for the schedule component 320 to perform a function related to a schedule item data object. In general, a function may include instructions for performing the function and function arguments in which argument values are used to complete the function. For example, if a function is intended to perform functionality of “changing the color of the schedule item on [DATE] to [COLOR],” then “[DATE]” and “[COLOR]” are function arguments of the function call. Consider, then, that a function call using that function has arguments of “red” and “May 31, 2024” as values, respectively, for arguments “[DATE]” and “[COLOR].” That function call then provides instructions for the schedule component 320 to “change the color of the calendar item on May 31^{st} to red.”

Examples of functions that can be performed by the schedule component 320 (e.g., in response to the one or more function calls) may include, but are not limited to including creating a new schedule item for a construction schedule, changing a name of a schedule item, changing priority information of a schedule item, changing status of a schedule item, changing a level of progress of a schedule item, changing a timeframe for a schedule item, changing details of a visual representation of a schedule item (e.g., changing a color of the visual representation, changing a font of the visual representation, changing a size of the visual representation, etc.), presenting details regarding a schedule item, exporting a visual representation of a construction schedule (e.g., printing a portion of the construction schedule to PDF), filtering schedule items shown on a construction schedule, and/or showing (or subsequently hiding) a visual indicator of schedule items that comprise a critical path to completing a construction project (or a given task thereof), among other contemplated functions.

The functionality of the schedule component 320 may take various other forms as well.

As noted above, after the natural-language query is received by the front-end interface 310, the front-end interface 310 may pass the natural-language query to the orchestrator component 315, which may generally function to (i) receive the natural-language request from the front-end interface 310, (ii) identify at least one AI agent (e.g., the AI agent 330 or another AI agent) that is to be utilized to handle the natural-language request and thereby determine where to route the natural-language request, (iii) route the natural-language request to the identified at least one AI agent for handling, (iv) receive a response from the identified at least one AI agent, and (v) pass the response back to the front-end interface 310.

At a high level, the function of identifying the at least one AI agent (e.g., the AI agent 330 or another AI agent) that is to be utilized to handle the natural-language request may involve determining which of at least one AI agent is best suited to handle the natural-language request. The orchestrator component 315 may make this identification in any of various manners.

As one possibility, the orchestrator component 315 may identify the at least one AI agent using the generative AI model 340. In this respect, the orchestrator component 315 may (i) generate a prompt comprising a request to determine which of the at least one AI agents is best suited to handle the natural-language request, (ii) pass the prompt as input to the generative AI model 340, (iii) receive a response from the generative AI model 340 comprising a prediction of which of the at least one AI agents is best suited to handle the natural-language request, and then (iv) use that prediction as a basis for identifying the at least one AI agent that is to be utilized to handle the incoming request.

As one example, consider that the natural-language request is a natural-language request to perform one or more actions within a Software tool. In this example, the orchestrator component 315 may function to (i) generate a prompt comprising a request to determine which of the at least one AI agents (e.g., the AI agent 330 or another AI agent) is best suited to handle the natural-language request to perform one or more actions within the Schedule tool, (ii) pass the prompt as input to an AI model (e.g., the generative AI model 340), (iii) receive a response from the AI model comprising a prediction that the AI agent 330 is best suited to handle the natural-language request (which may be a prediction that the AI agent 330 is best suited to handle the natural-language request because the AI agent 330 is preconfigured for transforming a user's natural-language request into one or more function calls for a software tool of a construction management software application), and then (iv) use that prediction as a basis for identifying that the AI agent 330 is to be utilized to handle the incoming request.

As another possibility, the orchestrator component 315 may identify the at least one AI agent using a different type of model, such as a discriminative AI model (e.g., a decision-tree model, neural-network-based model, a regression model, etc.) or a rule-based model. In this respect, the orchestrator component 315 may (i) generate a set of feature data based on the incoming request, (ii) pass the set of feature data as input to the discriminative AI or rule-based model, (iii) receive the output of discriminative AI or rule-based model, which may comprise a prediction of which one at least one AI agents is best suited to handle the natural-language request, and then (iv) use the output of the discriminative AI rule-based model as a basis for identifying the at least one AI agent is to be utilized to handle the natural-language request.

The function of identifying the at least one AI agent that is to be utilized to handle the incoming request may also take other forms.

As noted above, if orchestrator component 315 identifies that the natural-language request is a natural-language request to perform one or more actions within a software tool of the construction management software application (e.g., the Schedule tool), the orchestrator component 315 may pass the natural-language request to the AI agent 330. In accordance with the present disclosure, the AI agent 330 may take the form of a software component that provides an interface to a respective AI model (e.g., the generative AI model 340) and is preconfigured to perform particular AI-based functionality in order to accomplish a respective type of task that is preconfigured for the AI agent 330—which in this case involves AI-based functionality for transforming a user's natural-language request into one or more function calls for a software tool of a construction management software application. In some implementations, the AI agent 330 may be implemented in the form of a discrete executable software component, which is how the AI agent 330 is shown in FIG. 3 and described below for purposes of illustration. However, it should be understood that in other implementations, the AI agent 330 may be implemented in the form of a discrete configuration file (e.g., a YAML file) that, when loaded and executed by a centralized execution engine (e.g., an agent executor), causes the centralized execution engine to perform the functions for the AI agent. The AI agent 330 may take other forms as well.

At a high level, the AI-based functionality of the AI agent 330 may involve (i) receiving, from the orchestrator component 315, a natural-language request to perform one or more actions within a software tool of the construction management software application (e.g., the Schedule tool), (ii) based on the natural-language request, generating a prompt for the generative AI model 340 that comprises a request to determine which of a defined set of functions for the AI agent 330 to use in one or more function calls in order to carry out the one or more actions using the software tool (e.g. the schedule component 320), (iii) passing the prompt to the generative AI model 340, (iv) receiving a response from the generative AI model that comprises an identification of one or more of the defined set of functions for the AI agent 330 to utilize in one or more function calls, (v) either extracting the one or more function calls from the response (if included) or constructing the one or more function calls, (vi) passing the one or more function calls to the schedule component 320 and thereby cause the schedule component 320 to perform the one or more actions requested by the user, (vii) optionally receiving a response from the schedule component 320 indicating the result of the one or more function calls, and (viii) if such a response is received from the schedule component 320, passing the response to the front-end interface 310 (either directly or via one or more other software applications). Each of these functions may take any of various forms.

To begin, the function of receiving the natural-language request to perform one or more actions within a software tool of the construction management software application from the orchestrator component 315 may involve receiving the natural-language request from the orchestrator component 315 via an API, a messaging queue or bus, or some other form of inter-process communication.

Further, the natural-language request to perform the one or more actions within the Schedule tool of the construction management software application may take any of various forms. As representative examples, the natural-language request to perform the one or more actions within the Schedule tool of the construction management software application may comprise a request to create a new schedule item, a request to change a data field of a schedule item such as a name, a status, a level of progress, priority information, timing information (e.g., a start and/or end date), a CSI code, a location, etc., a request to change details of a visual representation of a schedule item (e.g., a color of the visual representation, a font of the visual representation, a size of the visual representation, etc.), a request to present details regarding a schedule item, a request to export a visual representation of a construction schedule (e.g., printing a portion of a construction schedule to PDF), a request to filter schedule items shown on a construction schedule, and/or a request to show or hide a visual indicator of schedule items that comprise a critical path to completing a construction project (or a given task thereof), among other possibilities. Additionally, the natural-language request to perform the one or more actions within the Schedule tool of the construction management software application may comprise a request to perform multiple actions together, such as a request to perform any of the foregoing actions with respect to a group of multiple different schedule items (e.g., a bulk update of a given data field across multiple different schedule items such as “Set all structural steel work starting after today to a 6-day/week calendar”) and/or a request to perform multiple different types of actions with respect to a single schedule item or a group of schedule items, among other possibilities.

The functionality for, based on the natural-language request, generating a prompt for the generative AI model 340 may take any of various forms. For instance, the prompt for the generative AI model that is generated by the AI agent 330 may comprise (i) the natural-language request, (ii) a defined set of functions that can be utilized by the schedule component 320 to perform one or more actions within the software tool (e.g., the Schedule tool), and (iii) a request for the generative AI model 340 to determine which one or more s of the defined set of functions to utilize in order to generate one or more function calls to carry out the one or more actions. In some examples, the prompt may further comprise a request to generate attribute values for respective attributes of each of the determined functions of the defined set of functions to utilize in order to generate one or more function calls to perform the one or more actions. In some examples, the prompt may comprise a request to, based on the determined one or more functions of the defined set of functions, generate the one or more function calls to perform the one or more actions.

The defined set of functions may take any of various forms. For example, the defined set of functions may comprise any functions for the schedule component 320 that cause the schedule component 320 to enable a user to perform at least one action related to a construction schedule. As one possibility, the defined set of functions may comprise a set of functions for the schedule component 320 that are encoded in software for the AI agent 330. As another possibility, the defined set of functions may be provided to the AI agent 330 by the schedule component 320 (e.g., in response to a request to the schedule component 320 sent via an API, a messaging queue or bus, or some other form of inter-process communication). The defined set of functions may take any of various forms, as well.

Consider an example wherein the AI agent 330 receives a natural-language request of the following form: “Change the color of the event on May 31st to red.” In this example, the AI agent 330 may generate a prompt (a “first example prompt,” as referenced below) that comprises the following:

$$“ [ natural - language request ] = “ Change the color of the event on May {31}^{st} to red . ” ; [ set of reference fu nctions ] = [ ( FUNC 1 ( having Arg . {1}_{1} , Arg . {1}_{2} , etc . ) ) ; ( FUNC 2 ( having Arg . {2}_{1} , Arg . {2}_{2} , etc . ) ) , etc . ] ;$$

i) Based on the following [natural-language request], determine a subset of functions from [set of reference functions] that could be used to generate one or more function calls for the Schedule tool that could be used to answer [natural-language request];
ii) Based on [natural-language request], determine values for each of the arguments (e.g., Arg. 1₁, Arg. 1₂, Arg. 2₁, Arg. 2₂, etc.) of each of the determined set of functions from “(i)”;
iii) return, as output, the determined subset of functions from “(i)” and the values for each of the arguments “(ii).””

As another possibility, the AI agent 330 may generate a prompt (a “second example prompt,” as referenced below) based on the above natural-language request that comprises the following:

$$“ [ natural - language request ] = “ Change the color of the event on May {31}^{st} to red . ” ; [ set of reference fu nctions ] = [ ( FUNC 1 ( having Arg . {1}_{1} , Arg . {1}_{2} , etc . ) ) ; ( FUNC 2 ( having Arg . {2}_{1} , Arg . {2}_{2} , etc . ) ) , etc . ] ;$$

i) Based on [natural-language request], determine a subset of functions from [set of reference functions] that could be used to generate one or more function calls for the Schedule tool that could be used to answer [natural-language request];
ii) Based on [natural-language request], determine values for each of the arguments (e.g., Arg. 1₁, Arg. 1₂, Arg. 2₁, Arg. 2₂, etc.) of each of the determined set of functions from “(i)”;
iii) Based on the determined subset of functions from “(i)” and the determined values for each of the arguments from “(ii),” generate one or more function calls call for the Schedule tool.
iv) return, as output, the generated function call of “(iii).””
   A prompt based on the natural-language request of “Change the color of the event on May 31^{st} to red.” may take various other forms, as well.

Returning again to the functionality of the AI agent 330, the AI agent's functions of passing the generated prompt to the generative AI model 340 and receiving the response from the generative AI model 340 may take any of various forms, which may depend in part on where the generative AI model 340 is hosted. For instance, in an implementation where the generative AI model 340 is hosted on a separate computing platform from the back-end computing platform 102, these functions may involve sending the generated prompt to the generative AI model 340 over an external network-based communication path (e.g., via an API or the like) and then receiving the response from the generative AI model 340 over the external network-based communication path. Alternatively, in an implementation where the generative AI model 340 is hosted on the back-end computing platform 102, these functions may involve sending the generated prompt via an internal communication path (e.g., an API, a messaging queue or bus, or some other form of inter-process communication) and then receiving the response from the generative AI model 340 over the internal communication path. The functions the AI agent 330 performs to pass the generated prompt to the generative AI model 340 and to receive the response from the generative AI model 340 may take other forms as well.

Further, the response from the generative AI model 340 that comprises an identification of the one or more determined functions of the defined set of functions for the AI agent 330 to utilize in one or more function calls may take any of various forms. Therefore, it follows that functionality for either (i) extracting the one or more function calls from the response from the generative AI model 340 or (ii) constructing the one or more function calls based on the response from the generative AI model 340 may take any of various forms (whether based on the form of the response or not).

As one possibility, the response may comprise (i) the one or more determined functions of the defined set of functions that could be used by the AI agent 330 to generate the one or more function calls, (ii) a set of candidate argument values for one or more respective arguments of each of the determined functions of the defined set of functions. If the response takes this form, then the AI agent 330 may construct the one or more function calls based on the response from the generative AI model 340. In practice, constructing the one or more function calls based on the response from the generative AI model 340 may comprise (i) generating a prompt comprising a request to, based on the received response, generate the one or more function calls, (ii) pass the prompt as input to an AI model (such as the generative AI model 340 or another AI model), and (iii) receive a response from the AI model comprising one or more generated function calls.

As another possibility, the response may comprise one or more generated function calls for the AI agent 330. The one or more generated function calls may each comprise (i) one of the determined one or more functions of the defined set of functions, and (ii) generated values for each of one or more respective arguments for the determined function. If the response takes this form, then the AI agent may extract the one or more function calls from the response from the generative AI model 340.

Further, the determined one or more functions of the defined set of functions may generally comprise any one or more functions from the defined set of functions that can be utilized to carry out the one or more actions requested by the user. For instance, line with the discussion above, the determined one or more functions may comprise a single function that can be utilized to carry out the one or more actions requested by the user and/or may comprise multiple functions that can be utilized to carry out the one or more actions requested by the user (e.g., a request to perform an action with respect to a group of multiple schedule items such as a bulk update of a given data field or a request to perform multiple types of actions with respect to a schedule item). And likewise, the one or more functional calls that are determined based on the response from the generative AI model 340 may comprise a single function call or multiple function calls.

As one example, consider the example above wherein the prompt input to the generative AI model 340 is the first example prompt, then the response to the AI agent 330 may comprise the following (either in natural language or in an encoded format):

$$“ Function for function call = \{ change the color of the schedule item on [ DATE ] to [ COLOR ] \} ;$$

### Argument Values for Function:

$$[ DATE ] = 5 / 31 / 2024 ; and [ COLOR ] = red . ”$$

As another example, consider the example above wherein the prompt input to the generative AI model 340 is the first example prompt, then the response to the AI agent 330 may comprise the following (either in natural language or in an encoded format usable directly by the AI agent 330 to perform the function call using the schedule component 320):

$$“ Function call = \{ change the color of the schedule item on [ 5 / 31 / 2024 ] to [ red ] \} . ”$$

Responses to either the first or second example prompts may take various other forms, as well.

The functionality for passing the one or more function calls to the schedule component 320 and thereby causing the schedule component 320 to carry out the one or more actions requested by the user may take any of various forms. This functionality may involve sending the one or more function calls to the schedule component 320 via an API, a messaging queue or bus, or some other form of inter-process communication.

Receiving a response from the schedule component 320 indicating the result of the one or more function calls may take various forms. As one possibility, the response from the schedule component 320 may comprise a visual indication indicating the result of the one or more function calls. For example, in the aforementioned example wherein the natural-language request comprises “Change the color of the event on May 31^{st} to red,” the visual indication indicating the result of the one or more function calls may comprise a visual representation of a construction schedule showing, at least, the date of May 31, 2024, wherein an indication of a schedule-item data object (having therein data values indicating a timeframe including May 31, 2024) is presented in red.

The functionality for, if such a response is received from the schedule component 320, passing the response to the front-end interface 310 (either directly or via one or more other software applications), may take any of various forms. For example, passing the response to the front-end interface 310 may involve transmitting the natural-language request from the AI agent 330 via an API, a messaging queue or bus, or some other form of inter-process communication.

The functionality of the AI agent 330 may take various other forms as well.

Turning next to the generative AI model 340, in line with the discussion above, the generative AI model 340 may generally function to (i) receive a prompt comprising a request to perform a task, (ii) perform the task, (iii) generate a response to the request that indicates the results of performing the task, and (iv) return the response to the software component from which the prompt was received.

For instance, as discussed above, the generative AI model 340 may (i) receive the prompt from the AI agent 330 comprising the request to determine which of the defined set of functions to utilize in order to carry out the one or more actions, (ii) generate a response comprising an identification of the one or more determined functions to utilize in order to carry out the one or more actions, as determined by the generative AI model 340, and (iii) return the response to the AI agent 330.

In this respect, the generative AI model's functions of determining which of the defined set of functions to utilize in order to carry out the one or more actions and generating the response comprising the identification of the one or more determined functions may take any of various forms, and in at least some implementations, may involve (i) analyzing the natural-language request to determine an intent of natural-language request, (ii) based on the intent of the natural-language request, determining one or more functions of the defined set of functions to select to utilize in order to carry out the one or more actions, (iii) based on the analysis of the natural-language request, determining argument values for function arguments of the one or more determined functions of the defined set of functions, (iv) optionally, based on the one or more determined functions and the determined argument values, generate one or more function calls for the AI agent 330, and (iv) generate the response comprising one or more of (a) an identification of the one or more functions for the AI agent 330 to utilize in one or more function calls, (b) argument values for function arguments of the determined one or more functions, (c) the generated one or more function calls, or combinations thereof.

The generative AI model 340 may receive various other types of requests and perform various other tasks as well.

The generative AI model 340 may take any of various forms. For instance, the generative AI model 340 may be a transformer-based model (e.g., a language model such as a large language model (LLM) and/or a multimodal model such as a vision-language model (VLM)), a diffusion model, a model based on a generational adversarial network (GAN), and/or a model based on a variational autoencoders (VAEs), among other possible types of generative AI models. Further, the generative AI model 340 may comprise a pre-trained generative AI model (e.g., an “off-the-shelf” generative AI model) that may or may not be further trained (e.g., via fine tuning, few-shot learning, or the like), or may comprise a generative AI model that is trained in the first instance to perform the tasks described herein, among other possibilities. Some representative examples of pre-trained generative AI models include a generative pre-trained transformer (GPT) type of generative AI model, a bidirectional encoder representations from transformers (BERT) type of generative AI model, a bidirectional auto-regressive transformer (BART) type of generative AI model, a text-to-text transfer transformer (T5) type of generative AI model, a pre-training with extracted gap sentences for abstractive summarization (PEGASUS) type of generative AI model, a large language model meta AI (LlaMA) type of generative AI model, a Phi-2 or Phi-3 type of generative AI model, a PaliGemma type of generative AI model, and/or a Florence-2 type of generative AI model, among other examples. The generative AI model 340 may take other forms as well.

As discussed above, in some implementations, the generative AI model 340 may be hosted on a computing platform that is separate from the back-end computing platform 102, in which case the generative AI model 340 may be accessed over a network-based communication path (e.g., via an API or the like), while in other implementations, the generative AI model 340 may be hosted on the back-end computing platform 102.

It should also be understood that the components of the example AI-based software architecture 300 could interface with multiple different generative AI models 340. For instance, as one possibility, different components of the example AI-based software architecture 300 could be configured to interface with multiple different generative AI models 340, which could be of the same type or of different types. As another possibility, the AI agent 330 could be configured to interface with multiple different generative AI models 340, which could be of the same type or of different types. Other configurations are possible as well.

The example AI-based software architecture 300 may take various other forms as well. For instance, as one possibility, the example AI-based software architecture 300 may include other components that are not shown or described above but may nevertheless facilitate the functionality disclosed herein. As another possibility, certain of the components shown and described above could be combined together or separated out into multiple sub-components. For example, in an implementation the AI agent 330 is implemented in the form of a configuration file that is executed by a centralized execution engine, the centralized execution engine could be combined together with the orchestrator component 315. As another example, the front-end interface 310 could be combined together with the orchestrator component 315. Other examples are possible as well. As yet another possibility, certain of the components shown and described above may perform additional or different functionality from what is described above. For example, in addition to the functionality described above, the orchestrator component 315 may function to decompose the incoming request into a set of subqueries that are to be handled by the AI agent 330 (and/or some other AI agent) so as to facilitate the task of interpreting and responding to the incoming request. Other variations of the example AI-based software architecture 300 are possible as well.

In line with the discussion above, it is also possible that the front-end interface 310 and the orchestrator component 315 of the example AI-based software architecture 300 could receive other types of incoming requests related to a software tool that should be routed to and handled by a different software component from the AI agent 330. Some illustrative examples of these other type of requests will now be described below with reference to the Schedule tool, but it should be understood that the requests could be related to other software tools and/or take other forms as well.

For instance, as one possibility, the front-end interface 310 and the orchestrator component 315 of the example AI-based software architecture 300 could receive a natural-language request to identify data objects of some other type (e.g., submittal data objects, RFI data objects, etc.) that are related to a given schedule item that is selected within the Schedule tool. In this respect, the orchestrator component 315 may determine that the request is best handled by another software component (e.g., with the assistance of the generative AI model 340 and/or some other generative AI model) and then route the request to that other software component, which could take the form of an AI agent that is preconfigured to perform AI-based functionality for identifying data objects of some other type that are related to a given schedule item. In turn, such an AI agent may function to interface with a search component that functions to perform any of various types of searches (e.g., vector-based semantic search, text-based search, etc.) and/or an AI model (e.g., a generative AI model, a discriminative AI model, a rule-based model, etc.) in order to facilitate the AI agent's identification of the data objects that are related to the given schedule item. For example, such an AI agent may function to generate and send a search query to a search component seeking an identification of data objects that are related to the given schedule item, and/or to generate and send a prompt to a generative AI model comprising a request to identify data objects that are related to the given schedule item, among other possibilities, and the AI agent may then utilize the responses from one or both of these other components as a basis for generating a response to the request and then passing that back to the orchestrator component 315 and/or the front-end interface 310. Along similar lines, the front-end interface 310 and the orchestrator component 315 of the example AI-based software architecture 300 could receive requests to identify other types of data objects together as well.

After handling the user's request to identify data objects of some other type that are related to the given schedule item, the AI agent (and/or some other software component) may also perform any of various other functions with respect to the identified data objects. For example, the AI agent (and/or some other software component) could link the identified data objects to the given schedule item or update one or more data fields of the given schedule item (e.g., a CSI code, a location, etc.) based on the identified data objects, among other possible examples.

An AI agent that is preconfigured to perform the AI-based functionality for identifying data objects of some other type that are related to a schedule item could also perform that functionality independently from any user request. For instance, such an AI agent may function to identify related data objects for schedule items automatically (i.e., without being requested by a user), such as by performing this functionality periodically with respect to the schedule items within a construction schedule. And along similar lines, the AI agent could perform functions such as linking identified data objects to schedule items and/or updating data fields of schedule items automatically (i.e., without being requested by a user).

The functionality that may be performed for identifying data objects that are related to a schedule item may take various other forms as well.

Other examples of AI agents (and/or other software components) for performing additional functionality related to the Schedule-tool functions described herein are possible as well.

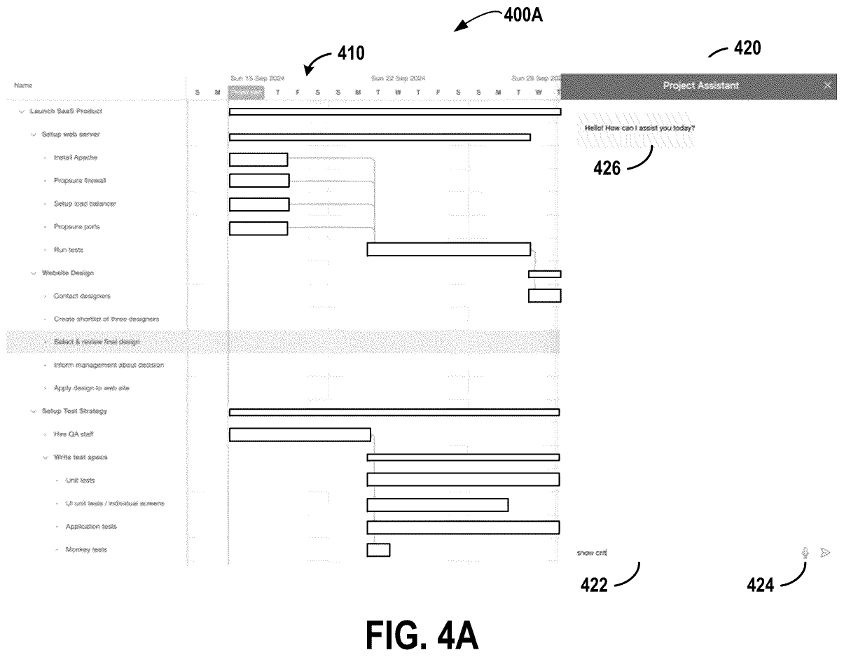

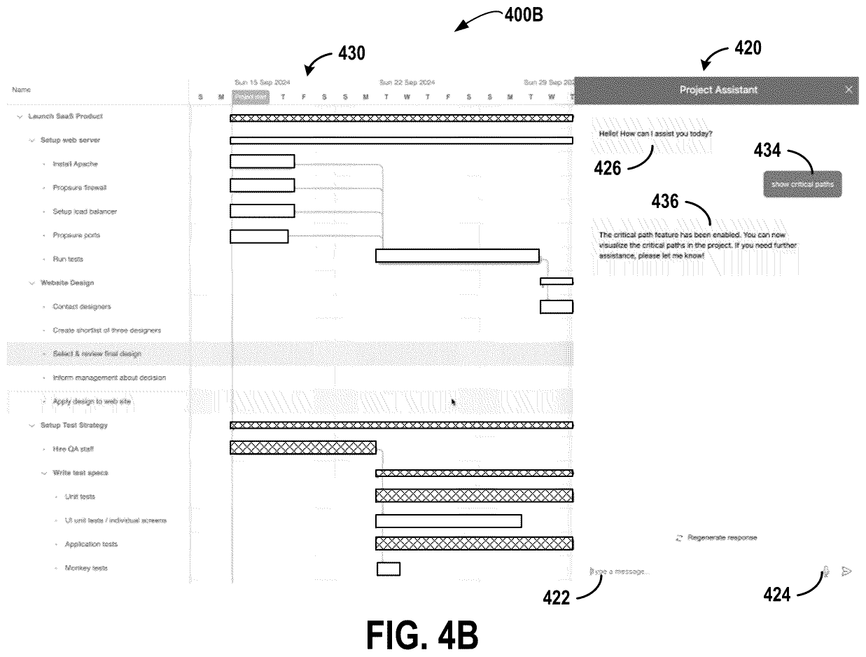

FIG. 4A shows an example first GUI view 400A comprising an example schedule view 410 output by the construction management software application (e.g., using a Schedule tool) and presented to the user of a client device 104 by way of front-end software. As shown, the schedule view 410 is overlaid with a chat interface 420 (which may be associated with an AI-based digital assistant of the construction management software platform).

As further shown, the chat interface 420 may comprise a text box 422 that enables the user to input a natural-language request in text format. In some examples, the chat interface may comprise an input-control element 424 that enables a user to initiate a session for inputting a natural-language request in an audio format using an I/O component of the client device 104 that captures audio. As illustrated, the chat interface 420 may present the user with a message 426 that solicits the user to provide input to the chat interface 420 that takes the form of a natural-language request (e.g., as text or voice input).

FIG. 4B shows an example second GUI view 400B, which is an updated version of the first GUI view 400A of FIG. 4A. The second GUI view 400B comprises an updated schedule view 430 that is an updated version of the schedule view 410 of FIG. 4A that has been updated by the schedule component 320 altering a the schedule view 410 to a modified schedule view 430, by way of the disclosed AI-based software architecture 300 carrying out at least some of the functionality disclosed herein.

The schedule view 410 is updated to the updated schedule view 430 in response to a natural-language request 434. The natural-language request 434 may have been input by a user using the chat interface (e.g., as text input to the text box 422 or audio input via the input-control element 424). For example and as illustrated, the language content of the natural-language request 434 may read “show critical paths.”

Updating the schedule view 410 to the updated schedule view 430 may occur because the back-end computing platform 102 carried out at least some of the disclosed functionality of the AI-based software architecture 300, discussed above. For instance, updating the schedule view 410 to the updated schedule view 430 may be a result of the AI-based software architecture 300(i) receiving the natural-language request 434 representative of a request to perform one or more actions requested by the user (e.g., showing critical paths), (ii) transforming the natural-language request into one or more function calls for a software tool (e.g., the Schedule tool) by using the generative AI model 340, (iii) perform the updating of the schedule view 410 to the updated schedule view 430 based on the one or more function calls, and (iv) presenting to the user, via a client device, the updated schedule view 430.

The updated schedule view 430 highlights indications of schedule items that are considered in a critical path to completion of a construction project represented by a schedule in the schedule views 410, 430. For example, the indications of schedule items that reside in the critical path to completion of the construction project are highlighted in the schedule view 430 with the hatched boxes. However, in practice, the indications of schedule items that reside in the critical path to completion of the construction project may be highlighted in other visual ways, such as changing the color of the indications of schedule items that reside in the critical path to completion of the construction project.

Output in response to the natural-language request 434 may take any of various other forms in addition to the visual representation illustrated by the updated schedule view 430. For example, output in response to the natural-language request 434 may include a natural language response that explains the actions performed (e.g., “The critical path feature has been enabled. You can now visualize the critical paths in the project. If you need further assistance, please let me know!”). Further, output in response to the natural-language request 434 may take any of various other forms.

Further still, the second GUI view 400B may include an interface of an AI assistant of the construction management software platform. For example, the chat interface 420 may be a chat interface for an AI assistant of the construction management software platform. The AI assistant may utilize the AI-based software architecture 300 to execute one or more function calls using the Schedule tool.

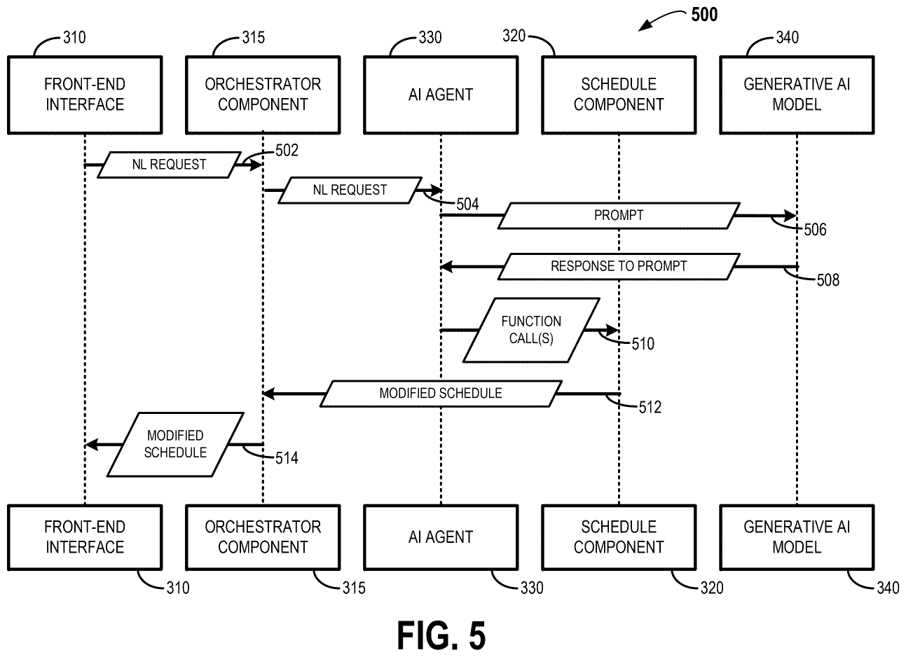

Turning now to FIG. 5, a communication diagram 400 that depicts communications between components shown in FIG. 3 is shown in accordance with the functionality disclosed herein. The communication diagram 500 illustrates the respective source and respective destination of each communication depicted therein. In addition, the communication diagram 500 illustrates one possible sequence of the communications shown. However, some of the communications shown may occur concurrently and/or in sequences that differ from the sequence shown. Furthermore, in some implementations, two or more of the communications shown may be combined into a single communication and/or a single communication may be divided into multiple communications. Also, in some implementations, the disclosed functionality may involve additional communications that are not depicted in the communication diagram 400.

Prior to arrow 502, a client device 104 running the front-end software for the construction management software application sends a natural-language request, which is subsequently received by the front-end interface 310. The natural-language request that is received by the front-end interface 310 may take any of the various forms discussed above, and for purposes of this example, will be assumed to be a request for performing one or more actions related to a software tool (e.g., the Schedule tool).

At arrow 502, the front-end interface 310 sends the natural-language request, which is subsequently received by the orchestrator component 315. The natural-language request that is received by the orchestrator component 315 may take any of the various forms discussed above.

At the arrow 504, the orchestrator component 315 passes the received natural-language request to the AI agent 330. After receiving the incoming natural-language request, the AI agent 330 generates a prompt for the generative AI model 340 that comprises a request to determine which of a defined set of functions for the AI agent 330 to use in one or more function calls in order to carry out the one or more actions using the software tool.

The prompt for the generative AI model that is generated by the AI agent 330 may comprise (i) the natural-language request, (ii) a defined set of functions that can be utilized by the schedule component 320 to perform one or more actions using the software tool (e.g., the Schedule tool), and (iii) a request for the generative AI model 340 to determine which one or more functions of the defined set of functions to utilize in order to generate one or more function calls to carry out the one or more actions. In some examples, the prompt may further comprise a request to generate attribute values for respective attributes of each of the determined one or more functions of the defined set of functions to utilize in order to generate one or more function calls to perform the one or more actions. In some examples, the prompt may comprise a request to, based on the determined one or more functions of the defined set of functions, generate the one or more function calls to perform the one or more actions.

At arrow 506, the AI agent 330 passes the prompt to the generative AI model 340 as input. After receiving the prompt, the generative AI model 340 may generate a response that comprises an identification of one or more of the defined set of functions for the AI agent 330 to utilize in one or more function calls.

At arrow 508, the AI agent 330 receives the response that comprises the identification of one or more of the defined set of functions for the AI agent 330 to utilize in one or more function calls. Based on the response, the AI agent 330 may either extract the one or more function calls from the response (if a generated function call is included in the response) or construct the one or more function calls.

At arrow 510, the AI agent 330 passes the one or more function calls to the schedule component 320 and thereby cause the schedule component 320 to perform the one or more actions requested by the user. In response to the one or more function calls, the schedule component 320 may modify an initial construction schedule and/or any schedule-items thereof to a modified construction schedule.

At arrow 512, the schedule component 320 may pass an indication (e.g., a GUI view) of the modified construction schedule to the orchestrator component 315 (e.g., by way of passing through the AI agent 330).

At arrow 512, orchestrator component 315 sends the indication of the modified construction schedule to front-end interface 310 along with an instruction to present the indication of the modified construction schedule to the user. The indication of the modified construction schedule and the instruction to present the indication of the modified construction schedule to the user may then be transmitted to a client device 104 and then presented to the user.

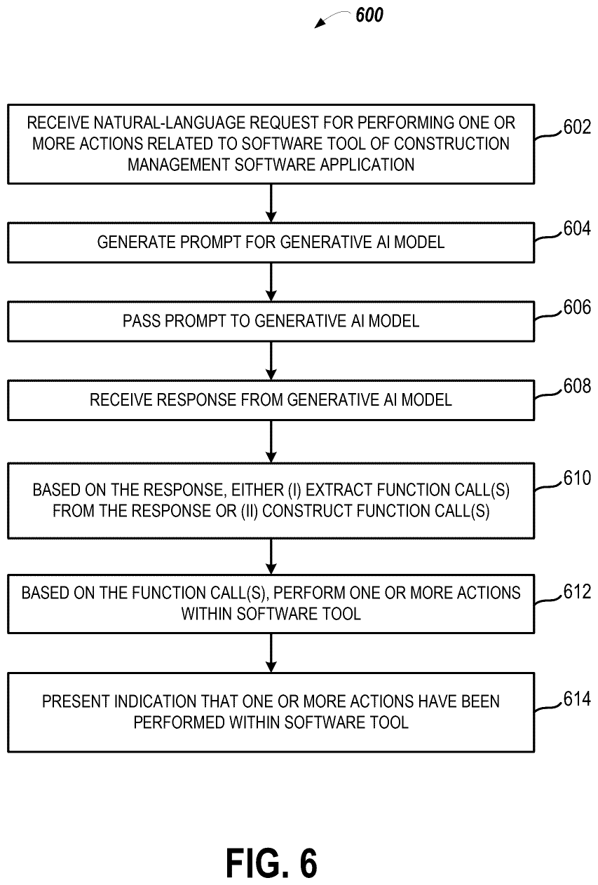

Turning to FIG. 6, example functionality 600 is illustrated in the form of a flow diagram. For purposes of illustration, the example functionality 600 of FIG. 6 is described as being carried out by the back-end computing platform 102 of FIG. 1, which is hosting a construction management software application, but it should be understood that the example functionality 600 of FIG. 6 may be carried out by any computing platform that is capable of running the software disclosed herein. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 6, the example functionality 600 may begin at block 602 with the disclosed AI-based software architecture receiving, from a client device 104, a natural-language request for performing one or more actions related to a software tool of a construction management software application. In line with the previous discussion with respect to the example AI-based software architecture 300, the input that is received and natural-language query may take various forms, and the user input may be initiated at any of various times.

At block 604, the disclosed AI-based software architecture may generate a prompt for a generative AI model that comprises a request to determine which of a defined set of functions for the software tool to use in one or more function calls in order to perform one or more actions using the software tool. In line with the discussion above with respect to the example AI-based software architecture 300, the prompt may further include one or more of (i) the defined set of functions for the software tool, (ii) a request to generate values for each of the one or more respective function arguments, (iii) a request to, based on (a) the determined functions of the defined set of functions and (b) the generated values for each of the one or more respective functions, generate the one or more function calls, or (iv) combinations thereof.

At block 606, the disclosed AI-based software architecture may pass the prompt to the generative AI model and, at block 608, the disclosed AI-based software architecture may receive, from the generative AI model, a response that comprises an identification of one or more determined functions of the defined set of functions to utilize in one or more function calls. In line with the previous discussion with respect to the example AI-based software architecture 300, functions of passing the generated prompt to the generative AI model and receiving the response from the generative AI model may take any of various forms (which may depend in part on where the generative AI model is hosted).

At block 610, the disclosed AI-based software architecture may, based on the response, either (i) extract the one or more function calls from the response or (ii) construct the one or more function calls. In line with the previous discussion with respect to the example AI-based software architecture 300, constructing the one or more function calls may comprise (i) generating a function-call prompt comprising a request to, based on the received response, generate the one or more function calls, (ii) passing the function-call prompt to an AI model (e.g., the generative AI model 340), and (iii) receiving a function-call response from the AI model comprising one or more generated function calls.

At block 612, the disclosed AI-based software architecture may, based on the one or more function calls, perform the one or more actions within the software tool. In line with the previous discussion with respect to the example AI-based software architecture 300, performing the one or more actions within the software tool may be performed using an API associated with the software tool.

At block 614, the disclosed AI-based software architecture may present, using the client device 104, an indication that the one or more actions have been performed within the software tool.

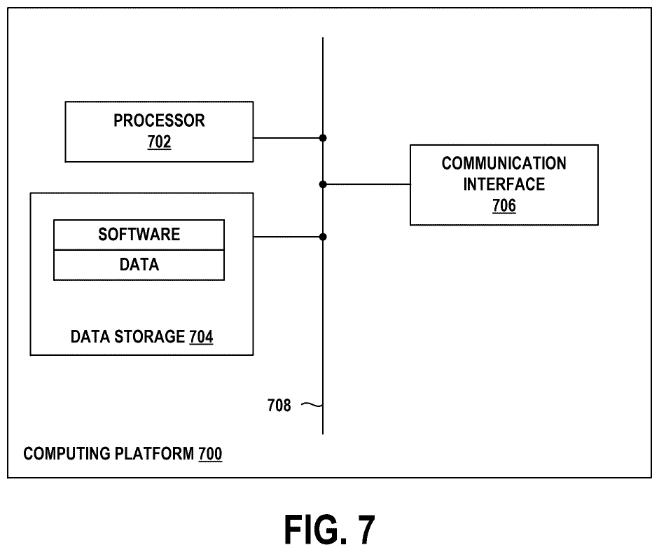

Turning now to FIG. 7, a simplified block diagram is provided to illustrate some structural components that may be included in an example computing platform 700 that may be configured to perform the platform-side functions disclosed herein. At a high level, the example computing platform 700 may generally comprise any one or more computer systems (e.g., one or more servers) that collectively include one or more processors 702, data storage 704, and one or more communication interfaces 706, each of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, the data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, the data storage 704 may be capable of storing both (i) program instructions that are executable by the one or more processors 702 such that the example computing platform 700 is configured to perform any of the various functions disclosed herein (including but not limited to any of the platform-side functions discussed above), and (ii) data that may be received, derived, or otherwise stored by the example computing platform 700.

The one or more communication interfaces 706 may comprise one or more interfaces that facilitate communication between the example computing platform 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication n (e.g., Wi-Fi communication, cellular communication, Bluetooth® communication, etc.), and/or any other interface that provides for wireless or wired communication. Other configurations are possible as well.

Although not shown, the example computing platform 700 may additionally have an I/O interface that includes or provides connectivity to I/O components that facilitate user interaction with the example computing platform 700, such as a keyboard, a mouse, a trackpad, a display screen, a touch-sensitive interface, a stylus, a virtual-reality headset, and/or one or more speaker components, among other possibilities.

It should be understood that the example computing platform 700 is one example of a computing platform that may be used with the examples described herein. Numerous other arrangements are possible and contemplated herein. For instance, in other examples, the example computing platform 700 may include additional components not pictured and/or more or less of the pictured components.

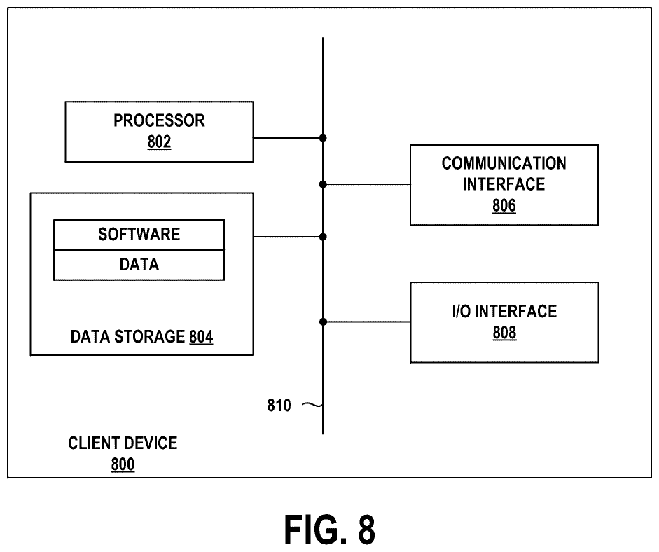

Turning next to FIG. 8, a simplified block diagram is provided to illustrate some structural components that may be included in an example client device 800 that may be configured to perform some the client-side functions disclosed herein. At a high level, the example client device 800 may include one or more processors 802, data storage 804, one or more communication interfaces 806, and an I/O interface 808, each of which may be communicatively linked by a communication link 810 that may take the form a system bus and/or some other connection mechanism. Each of these components may take various forms.

For instance, the one or more processors 802 of the example client device 800 may comprise one or more processor components, such as one or more CPUs, GPUs, ASICS, DSPs, and/or programmable logic devices such as FPGAs, among other possible types of processing components.

In turn, the data storage 804 of the example client device 800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 8, the data storage 804 may be capable of storing both (i) program instructions that are executable by the one or more processors 802 of the example client device 800 such that the example client device 800 is configured to perform any of the various functions disclosed herein (including but not limited to any of the client-side functions discussed above), and (ii) data that may be received, derived, or otherwise stored by the example client device 800.

The one or more communication interfaces 806 may comprise one or more interfaces that facilitate communication between the example client device 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 808 may generally take the form of (i) one or more input interfaces that are configured to receive and/or capture information at the example client device 800 and (ii) one or more output interfaces that are configured to output information from the example client device 800 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 808 may include or provide connectivity to output components such as a display screen and/or an audio speaker, among other possibilities.

It should be understood that the example client device 800 is one example of a client device that may be used with the examples described herein. Numerous other arrangements are possible and contemplated herein. For instance, in other examples, the example client device 800 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

What is claimed is:

1. A computing platform comprising:
at least one non-transitory computer-readable medium;
at least one processor; and
program instructions stored on the at least one non-transitory computer-readable medium that, when executed by the at least one processor, cause the computing platform to:
receive, from a client device, a natural-language request for performing one or more actions related to a software tool of a construction management software application;
based on the natural-language request, generate a prompt for a generative AI model that comprises a request to determine which of a defined set of functions for the software tool to use in one or more function calls in order to perform one or more actions using the software tool;
pass the prompt to the generative AI model;
receive, from the generative AI model, a response that comprises an identification of one or more determined functions of the defined set of functions to utilize in one or more function calls;
based on the response, either (i) extract the one or more function calls from the response or (ii) construct the one or more function calls;
based on the one or more function calls, perform the one or more actions within the software tool; and
present, using the client device, an indication that the one or more actions have been performed within the software tool.

2. The computing platform of claim 1, wherein the prompt further comprises the defined set of functions for the software tool.

3. The computing platform of claim 1, wherein one or more of the determined functions of the defined set of functions comprises one or more respective function arguments, and
wherein the prompt further comprises a request to generate values for each of the one or more respective function arguments.

4. The computing platform of claim 3, wherein the prompt further comprises a request to, based on (i) the determined functions of the defined set of functions and (ii) the generated values for each of the one or more respective functions, generate the one or more function calls.

5. The computing platform of claim 3, wherein the program instructions that, when executed by the at least one processor, cause the computing platform to, based on the response, either (i) extract the one or more function calls from the response or (ii) construct the one or more function calls, cause the computing platform to:
based on (i) the determined functions of the defined set of functions and (ii) the generated values for each of the one or more respective functions, construct the one or more function calls.

6. The computing platform of claim 5, wherein the program instructions that, when executed by the at least one processor, cause the computing platform to, based on (i) the determined functions of the defined set of functions and (ii) the generated values for each of the one or more respective functions, construct the one or more function calls, cause the computing platform to:
generate a function-call prompt comprising a request to, based on the received response, generate the one or more function calls;
pass the function-call prompt to an AI model; and
receive a function-call response from the AI model comprising one or more generated function calls.

7. The computing platform of claim 1, wherein the program instructions that, when executed by the at least one processor, cause the computing platform to, based on the natural-language request, generate a prompt for a generative AI model that comprises a request to determine which of a defined set of functions for the software tool to use in the one or more function calls in order to perform one or more actions using the software tool comprises:
based on the natural-language request and using an AI agent, generate a prompt for a generative AI model that comprises a request to determine which of a defined set of functions for the software tool to use in the one or more function calls in order to perform one or more actions using the software tool; and
the computing platform further comprising program instructions stored on the at least one non-transitory computer-readable medium that, when executed by the at least one processor, cause the computing platform to:
identify at least one of a plurality of candidate AI agents that is to be utilized to handle the natural-language request and thereby determine where to route the natural-language request; and
route the natural-language request to the identified at least one candidate AI agent for handling the natural-language request,
wherein the plurality of candidate AI agents comprises the AI agent.

8. The computing platform of claim 1, wherein the software tool is a schedule tool of the construction management software application.

9. A non-transitory computer-readable medium having stored thereon program instructions that, when executed by at least one processor, cause a computing platform to:
receive, from a client device, a natural-language request for performing one or more actions related to a software tool of a construction management software application;
based on the natural-language request, generate a prompt for a generative AI model that comprises a request to determine which of a defined set of functions for the software tool to use in one or more function calls in order to perform one or more actions using the software tool;
pass the prompt to the generative AI model;
receive, from the generative AI model, a response that comprises an identification of one or more determined functions of the defined set of functions to utilize in one or more function calls;
based on the response, either (i) extract the one or more function calls from the response or (ii) construct the one or more function calls;
based on the one or more function calls, perform the one or more actions within the software tool; and
present, using the client device, an indication that the one or more actions have been performed within the software tool.

10. The non-transitory computer-readable medium of claim 9, wherein the prompt further comprises the defined set of functions for the software tool.

11. The non-transitory computer-readable medium of claim 9, wherein one or more of the determined functions of the defined set of functions comprises one or more respective function arguments, and
wherein the prompt further comprises a request to generate values for each of the one or more respective function arguments.

12. The non-transitory computer-readable medium of claim 11, wherein the prompt further comprises a request to, based on (i) the determined functions of the defined set of functions and (ii) the generated values for each of the one or more respective functions, generate the one or more function calls.

13. The non-transitory computer-readable medium of claim 11, wherein the program instructions that, when executed by the at least one processor, cause the computing platform to, based on the response, either (i) extract the one or more function calls from the response or (ii) construct the one or more function calls, cause the computing platform to:
based on (i) the determined functions of the defined set of functions and (ii) the generated values for each of the one or more respective functions, construct the one or more function calls.

14. The non-transitory computer-readable medium of claim 13, wherein the program instructions that, when executed by the at least one processor, cause the computing platform to, based on (i) the determined functions of the defined set of functions and (ii) the generated values for each of the one or more respective functions, construct the one or more function calls, cause the computing platform to:
generate a function-call prompt comprising a request to, based on the received response, generate the one or more function calls;
pass the function-call prompt to an AI model; and
receive a function-call response from the AI model comprising a one or more generated function calls.

15. The non-transitory computer-readable medium of claim 9, wherein the program instructions that, when executed by the at least one processor, cause the computing platform to, based on the natural-language request, generate a prompt for a generative AI model that comprises a request to determine which of a defined set of functions for the software tool to use in one or more function calls in order to perform one or more actions using the software tool comprises:
based on the natural-language request and using an AI agent, generate a prompt for a generative AI model that comprises a request to determine which of a defined set of functions for the software tool to use in one or more function calls in order to perform one or more actions using the software tool; and
the program instructions that, when executed by at least one processor, further cause a computing platform to:
identify at least one of a plurality of candidate AI agents that is to be utilized to handle the natural-language request and thereby determine where to route the natural-language request; and
route the natural-language request to the identified at least one candidate AI agent for handling the natural-language request,
wherein the plurality of candidate AI agents comprises the AI agent.

16. The non-transitory computer-readable medium of claim 9, wherein the software tool is a schedule tool of the construction management software application.

17. A method carried out by a computing platform, the method comprising:
receiving, from a client device, a natural-language request for performing one or more actions related to a software tool of a construction management software application;
based on the natural-language request, generating a prompt for a generative AI model that comprises a request to determine which of a defined set of functions for the software tool to use in one or more function calls in order to perform one or more actions using the software tool;
passing the prompt to the generative AI model;
receiving, from the generative AI model, a response that comprises an identification of one or more determined functions of the defined set of functions to utilize in one or more function calls;
based on the response, either (i) extracting the one or more function calls from the response or (ii) constructing the one or more function calls;
based on the one or more function calls, performing the one or more actions within the software tool; and
presenting, using the client device, an indication that the one or more actions have been performed within the software tool.

18. The method of claim 17, wherein one or more of the determined functions of the defined set of functions comprises one or more respective function arguments, and
wherein the prompt further comprises a request to generate values for each of the one or more respective function arguments.

19. The method of claim 18, wherein the prompt further comprises a request to, based on (i) the determined functions of the defined set of functions and (ii) the generated values for each of the one or more respective functions, generate the one or more function calls.

20. The method of claim 18, wherein, based on the response, either (i) extract the one or more function calls from the response or (ii) construct the one or more function calls comprises:
generating a function-call prompt comprising a request to, based on the received response, generate the one or more function calls;
passing the function-call prompt to an AI model; and
receiving a function-call response from the AI model comprising one or more generated function calls.
